(19) United States
(12) Patent Application Publication
(10) Pub. No.: US 2026/0200385 A1
(43) Pub. Date: Jul. 16, 2026

(54) COLLAPSIBLE FOLDING TABLE ASSEMBLY

(71) Applicants: ATEC INTERNATIONAL TEAM CO., LTD., Taoyuan City (TW); GAUSS SEATING CO., LTD., Tainan City (TW)

(72) Inventors: Te-Chun Chen, Taoyuan City (TW); Chin-Hu Yen, Tainan City (TW)

(21) Appl. No.: 19/021,021

(22) Filed: Jan. 14, 2025

(51) Int. Cl. B60N 3/00; A47B 5/04

(52) U.S. Cl. CPC B60N 3/002; A47B 5/04

(57) ABSTRACT

A collapsible folding table assembly is designed for installation adjacent to seating areas. The tabletop is movable between a storage position within the internal space and an extended position outwardly from the housing. The tabletop is foldable for compact storage and is connected to the housing via a rotational mechanism that includes a pivot joint and a locking element. The main body housing is equipped with an inclined track mechanism, which comprises at least one guide rail inclined at a predetermined angle relative to the vertical axis of the housing to facilitate gravity-assisted movement of the tabletop during storage. A guiding component connected to the rotational mechanism interacts with the guide rail to guide the tabletop smoothly along the rail. The main body housing may include an inner shell and an outer shell, with noise reduction and vibration dampening materials positioned between the inner and outer shells.

### FIELD OF THE DISCLOSURE

The present invention generally relates to furniture assemblies, particularly collapsible and foldable table assemblies designed for installation in environments with limited or confined spaces, such as lecture halls, train compartments, airplanes, buses, and other public transportation or assembly areas.

### BACKGROUND OF THE INVENTION

n environments where space efficiency and flexibility are highly important, providing functional surfaces for activities such as writing, using electronic devices, or holding meetings is essential. Traditional fixed tables often lead to inefficient use of space in settings like lecture halls or train compartments, as they occupy valuable floor space even when not in use. To address this issue, various collapsible and foldable table assemblies have been developed to offer temporary workspaces that can be conveniently extended and stored as needed.

1. Operational Complexity: Many existing foldable tables require significant manual effort to extend and store, which can be cumbersome for users, especially in high-traffic environments or situations where rapid deployment and stowage are necessary.

2. Inefficient Storage Mechanisms: Existing designs may lack effective guiding systems, preventing smooth transitions of the table between positions. This can result in abrupt movements that may discomfort users or potentially damage the table and mounting structures.

3. Space Optimization Constraints: Some foldable tables fail to optimize the internal storage space of the main body housing, resulting in bulky or protruding assemblies that hinder seamless integration of the table assembly into existing environments.

In environments such as lecture halls and train compartments, where space is limited and user convenience is paramount, there remains a continuous demand for improved collapsible and foldable table assemblies. These enhanced assemblies should offer seamless operation for extending and storing, enhanced stability and durability, efficient space utilization, and user-friendly features that cater to the dynamic needs of these environments.

The present invention addresses these limitations by introducing a collapsible folding table assembly equipped with a uniquely designed inclined track mechanism. This inclined track mechanism facilitates smooth, gravity-assisted storage operations, thereby enhancing ease of use and reducing mechanical complexity. Additionally, the assembly integrates features aimed at optimizing space, ensuring stability during use, and providing durable solutions suitable for high-demand environments.

### SUMMARY OF THE INVENTION

The present invention relates to a collapsible folding table assembly designed for installation adjacent to seating areas, particularly suitable for environments where space optimization is crucial, such as lecture halls, train compartments, airplanes, buses, and various public or private venues. The collapsible folding table assembly provides a stable and functional workspace when the tabletop is extended and is efficiently stored when not in use, thereby conserving valuable floor or walkway space.

The collapsible folding table assembly comprises a main body housing that defines an internal space and is configured to be installed near a seating area. A tabletop is mounted within the main body housing and is movable between a storage position within the internal space and an extended position outwardly from the housing. The tabletop is foldable to allow it to be compactly stored within the housing, forming a space-efficient configuration.

A rotational mechanism connects the tabletop to the main body housing, enabling the tabletop to move between the storage and extended positions. This rotational mechanism includes a pivot joint and a locking element configured to secure the tabletop in the extended position. A support plate may be connected to the pivot joint to provide a rigid support structure when the tabletop is extended, enhancing stability during use.

An inclined track mechanism is installed within the main body housing, comprising at least one guide rail inclined at a predetermined angle relative to the vertical axis of the housing. This inclination angle is precisely selected to balance gravitational forces, allowing the tabletop to move smoothly under gravity assistance during the storage process, thereby preventing uncontrolled acceleration. The lower end of the inclined track mechanism is equipped with stop members to secure the tabletop in the storage position within the main body housing, preventing it from descending beyond the predetermined position.

Connected to the rotational mechanism is a guiding component that interacts with the guide rail of the inclined track mechanism to guide the tabletop's movement along the rail. This guiding component includes a guide block made from low-friction materials to prevent lateral movement and rollers attached to the guide block, suitable for rolling along the surface of the guide rail. The guide rail may be coated with low-friction materials, such as polytetrafluoroethylene (PTFE) or self-lubricating plastics, to ensure smooth operation.

The main body housing includes an inner shell that encloses the internal space and accommodates mechanical components, including the inclined track mechanism, and an outer shell that encases the inner shell. The space between the inner and outer shells may contain noise reduction and vibration dampening materials, such as foam pads or rubber layers, to reduce operational noise and absorb vibrations generated by internal mechanisms, thereby enhancing user comfort, especially in quiet environments.

The tabletop features a recessed area on its underside to facilitate user gripping and handling during extension and storage. Additionally, the tabletop includes a hinge mechanism that allows it to fold onto itself for more compact storage within the main body housing. The tabletop surface may be coated with non-slip materials to prevent items from sliding and may include raised edges or frames around its perimeter to enhance functionality and safety during use.

A supporting structure connects the rotational mechanism to the guiding component, providing additional stability during the tabletop's movement and ensuring smooth and controlled transitions between the storage and extended positions.

The design of the collapsible folding table assembly offers several advantages, including simplified operation through gravity-assisted storage, enhanced stability during use, efficient space utilization, and an improved user experience. By integrating these innovative features, the assembly provides a durable and user-friendly solution for applications requiring space-optimized and functional workspaces.

To make the above features and advantages of the present invention more apparent and understandable, a preferred embodiment is exemplified below, in conjunction with the accompanying drawings, for detailed description.

### BRIEF DESCRIPTION OF THE DRAWINGS

FIG. 1A is a perspective view of an exemplary embodiment of the collapsible folding table assembly according to the present invention.

FIG. 1B is a view of the collapsible folding table assembly with the outer shell concealed.

FIG. 2A and FIG. 2B are different perspective views of the tabletop of the collapsible folding table assembly according to the present invention.

FIG. 3A and FIG. 3B are views of the rotational mechanism of the collapsible folding table assembly in different states.

FIG. 4A and FIG. 4B are views of the inclined track mechanism and guiding component of the collapsible folding table assembly in different states, respectively.

FIG. 5 is an operational flowchart illustrating an exemplary embodiment of the collapsible folding table assembly according to the present invention.

### DESCRIPTION OF THE PREFERRED EMBODIMENTS

The present invention relates to a collapsible folding table assembly, specifically designed for installation adjacent to seating areas in environments where space optimization is crucial, such as lecture halls, train compartments, airplanes, buses, and various public or private venues. The collapsible folding table assembly provides a stable and functional workspace when extended and is efficiently stored when not in use, thereby conserving valuable floor or walkway space.

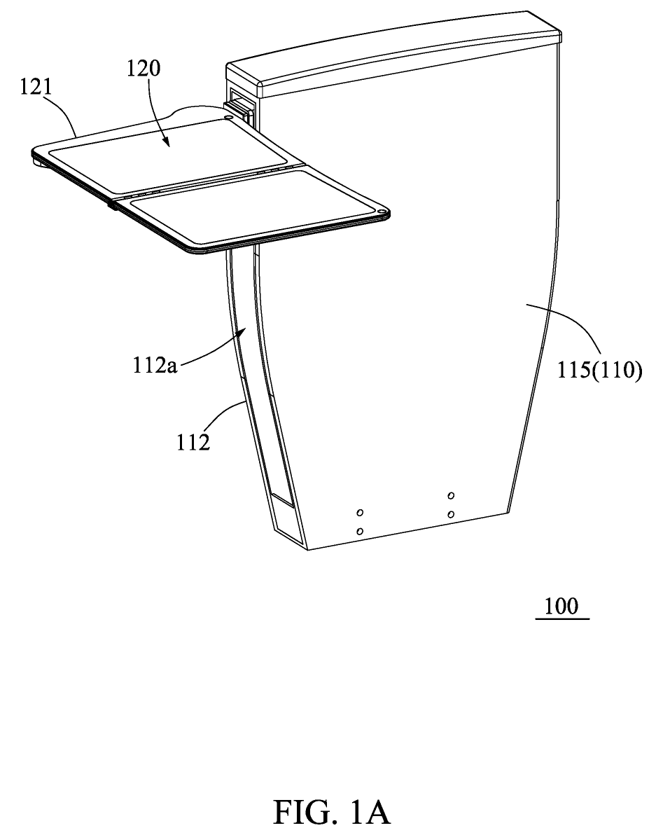

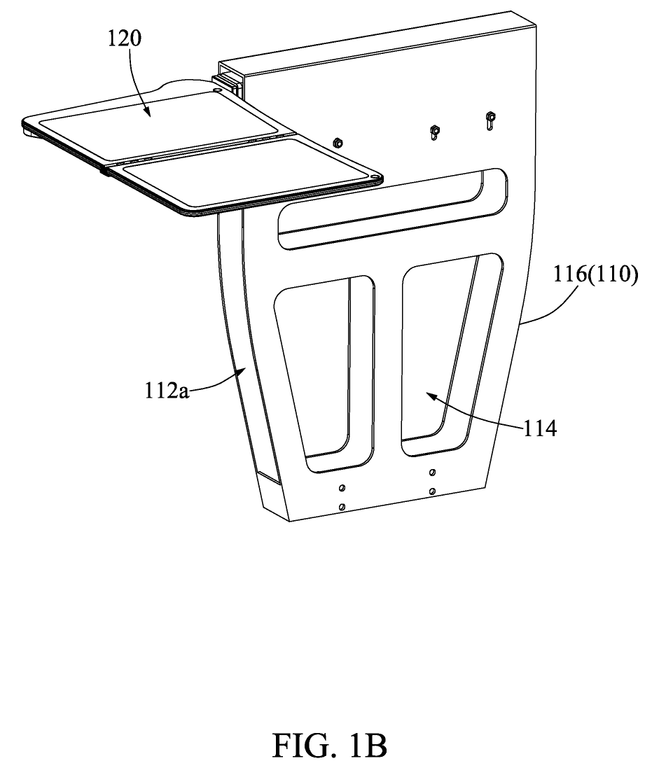

Referring to FIG. 1A, there is shown an exemplary embodiment of the collapsible folding table assembly according to the present invention, illustrating the appearance of the assembly when the tabletop is stored. The collapsible folding table assembly 100 comprises a main body housing 110, which is securely mounted to a structural component (not shown) near the seating area, such as a wall, partition, seat frame, or other fixed structure. The main body housing 110 typically has an approximately rectangular shape, with dimensions customizable based on the requirements of the tabletop and internal mechanisms. In this embodiment, the main body housing 110 features a streamlined appearance, with a slightly curved front edge 112 and an opening 112a. The slight curvature enhances aesthetic appeal, while the opening 112a provides access to the internal space 114 within the main body housing 110.

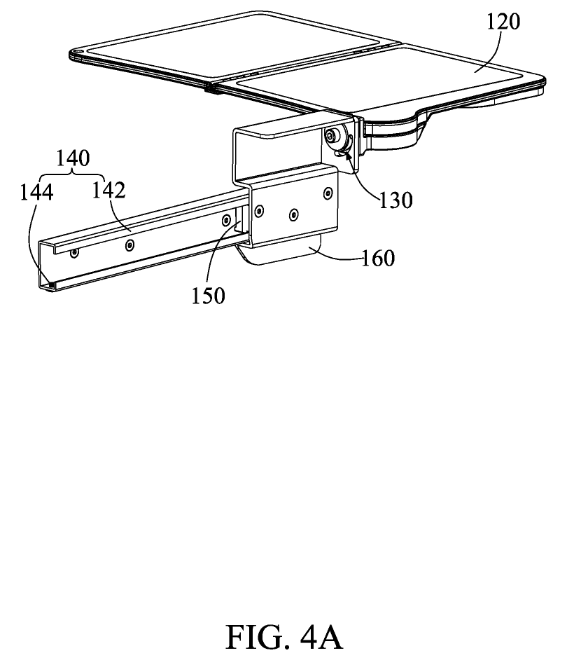

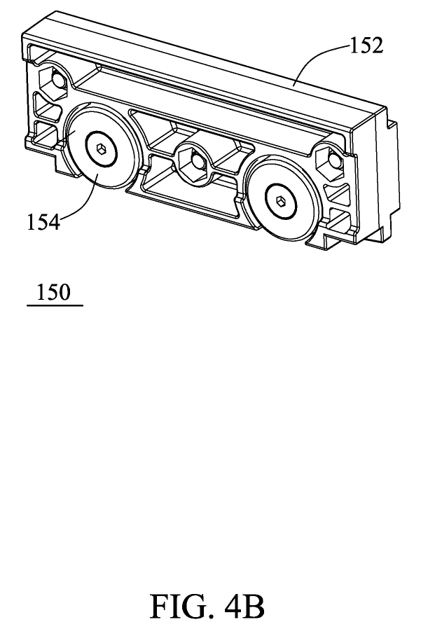

Referring also to FIG. 1B, which shows a view of the collapsible folding table assembly with the outer shell concealed. In this embodiment, the main body housing 110 comprises an outer shell 115 and an inner shell 116, each serving different yet complementary functions. The space surrounded by the inner shell 116 serves as an installation area for various mechanical components of the collapsible folding table assembly 100, including the tilting track mechanism 140 (as shown in FIG. 4A). The inner shell 116 is made of sturdy materials, providing a protected environment for the various mechanical components. Encasing the inner shell 116 is the outer shell 115, which acts as a protective casing, absorbing and dispersing external forces to enhance the structural integrity of the assembly. The outer shell 115 also improves the aesthetic appearance of the table assembly. It can be made from materials such as molded plastic, composites, or metals with various surface treatments, allowing it to seamlessly integrate with the interior design of the installation environment. The space between the outer shell 115 and the inner shell 116 can be utilized for noise reduction and vibration dampening. By combining the outer shell 115 and the inner shell 116, the design of the main body housing 110 achieves a balance of protection, functionality, and aesthetic customization. It enhances the durability of the assembly and ensures user safety by preventing contact with moving parts.

In other embodiments, foam pads or rubber layers may be installed in the gap between the inner shell and the outer shell (not installed in the embodiment shown in FIG. 1B) to minimize operational noise and absorb vibrations generated by the movement of internal mechanisms. This feature enhances user comfort, particularly in quiet environments such as lecture halls or libraries.

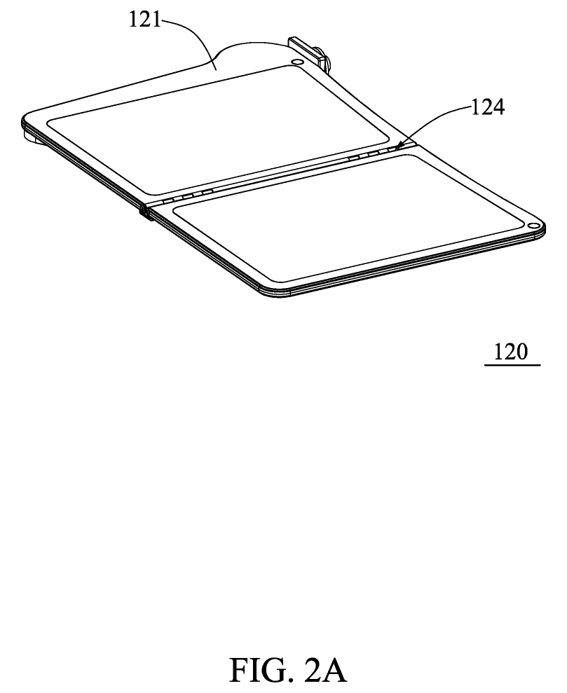

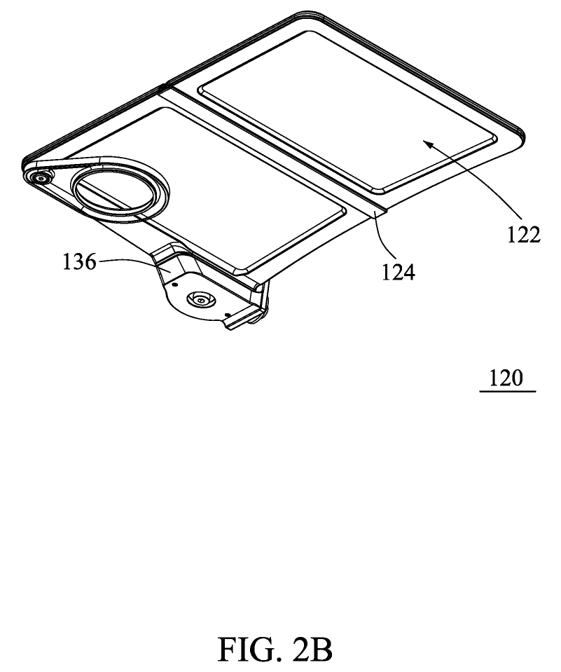

Referring to FIG. 2A and FIG. 2B, these figures show different perspectives of the tabletop of the collapsible folding table assembly according to the present invention. The collapsible folding table assembly 100 further includes a tabletop 120, which can be folded and stored within the internal space 114 of the main body housing 100 when not in use. In this embodiment, the tabletop 120 is rectangular in shape, sized appropriately for writing, reading, using a laptop or tablet computer, and dining. The tabletop 120 can be made from materials that balance strength and weight, such as laminated wood, composite boards, or metal sheets. To prevent items from slipping, especially in environments prone to movement or vibration like trains or buses, the tabletop 120 can be covered with non-slip materials such as rubber coatings or textured laminate boards. Alternatively, raised edges 121 or frames (not shown) can be installed around the perimeter of the tabletop to achieve the same effect. Referring to FIG. 2B, a recessed area 122 is provided beneath the tabletop 120 to facilitate easy gripping and handling by the user during extension and storage. Additionally, in this embodiment, the tabletop 120 is equipped with a hinge mechanism 124, allowing the tabletop 120 to fold when stored.

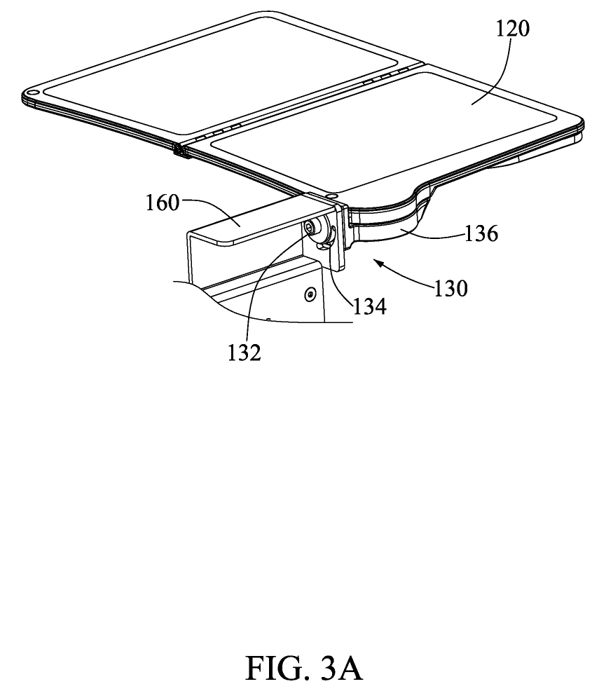

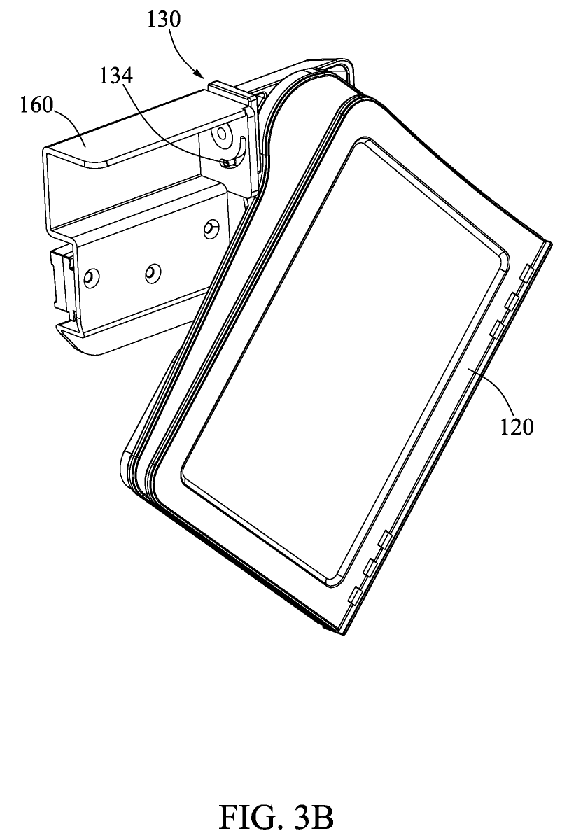

Referring to FIG. 3A and FIG. 3B, these figures illustrate the rotational mechanism of the collapsible folding table assembly in different states. The tabletop 120 is connected to the main body housing 110 via a rotational mechanism 130, which allows the tabletop 120 to smoothly rotate between the extended and stored positions. In this embodiment, the rotational mechanism 130 includes a pivot joint 132 made from durable materials such as stainless steel or reinforced polymers to withstand repeated use without degradation. To ensure the stability of the tabletop during use, as shown in the enlarged views of FIG. 3A and FIG. 3B, the rotational mechanism 130 is equipped with a locking element 134. When the tabletop 120 reaches the fully extended position, the locking element 134 prevents further rotation, thereby ensuring the safety and stability of the user while using the tabletop 120. Furthermore, to enhance the stability of the tabletop 120 when extended, the rotational mechanism 130 includes a support plate 136. One end of the tabletop 120 is hinged to the support plate 136, which forms a rigid support structure to bear the load applied during use, preventing bending or wobbling. Additionally, because one end of the tabletop 120 is hinged to the support plate 136, when the tabletop 120 is stored, it can rotate at an angle relative to the support plate 136 to facilitate storage.

Referring to FIG. 4A and FIG. 4B, FIG. 4A illustrates the tilting track mechanism of the collapsible folding table assembly according to the present invention, and FIG. 4B illustrates the guiding component of the collapsible folding table assembly. A notable feature of the collapsible folding table assembly 100 in this embodiment is the integrated tilting track mechanism 140 within the main body housing 110. The tilting track mechanism 140 includes at least one guide rail 142 inclined at a specific angle relative to the vertical axis of the main body housing 110. The angle of inclination is determined based on practical conditions to balance the gravitational force required to guide the tabletop 120 into the storage position without causing rapid or uncontrolled movement. The guide rail 142 is made from low-friction materials or treated with low-friction coatings, such as polytetrafluoroethylene (PTFE) coated metal or self-lubricating plastics, to ensure smooth operation.

Interacting with the tilting track mechanism 140 is the guiding component 150 connected to the rotational mechanism 130. In this embodiment, the guiding component 150 may include guide blocks 152 and rollers 154, designed to closely engage with the guide rail 142 and control the movement of the tabletop 120 along the inclined path. The guide blocks 152 are made from materials with inherent low friction, such as nylon or polyethylene. In this embodiment, the guide blocks 152 are covered and engaged with the guide rail 142 to prevent lateral movement. Additionally, in this embodiment, the rollers 154 further reduce friction by rolling along the bottom of the guide rail 142. This guiding component 150 ensures that when the user begins the storage process by folding and storing the tabletop 120 towards the main body housing 110, the weight of the tabletop 120 and the rotational mechanism 130 smoothly slides downward along the tilting track mechanism 140 under the influence of gravity. This movement is controlled and smooth, eliminating the need for the user to continuously apply force or manage complex locking mechanisms. The lower end of the tilting track mechanism 140 is equipped with stop members 144 (screws in this embodiment) to secure the tabletop 120 in the storage position within the main body housing 110. These stop members 144 prevent the tabletop 120 from descending beyond the predetermined position. Additionally, the collapsible folding table assembly 100 in this embodiment includes a supporting structure 160, which is a plate with multiple bends. One end of the supporting structure 160 is connected to the rotational mechanism 130, while the other end is locked with the guide block 152 of the guiding component 150.

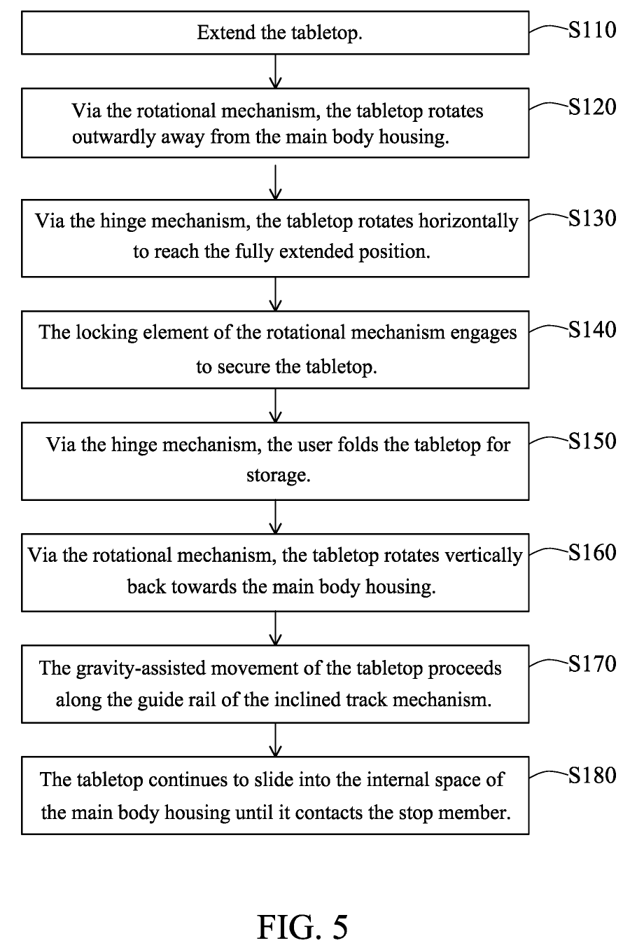

The collapsible folding table assembly 100 is simple and easy to operate. Referring to FIG. 5, which illustrates an operational flowchart of an exemplary embodiment of the collapsible folding table assembly according to the present invention. First, as shown in step S110, to extend the tabletop 120, the user grasps the recessed area 122 integrated beneath the tabletop 120. Next, as shown in step S120, through the rotational mechanism 130, the tabletop 120 rotates outward away from the main body housing 110. Then, as shown in step S130, via the hinge mechanism 124, the tabletop 120 rotates horizontally to reach the fully extended position. Subsequently, as shown in step S140, the locking element 134 of the rotational mechanism 130 engages to secure the tabletop 120, preventing further rotation and ensuring user safety and stability while using the tabletop 120. To store the tabletop 120, as shown in step S150, the user begins to fold the tabletop 120 through the hinge mechanism 124. Then, as shown in step S160, via the rotational mechanism 130, the tabletop 120 rotates vertically back towards the main body housing 110. Next, as shown in step S170, assisted by gravity, the tabletop 120 moves along the guide rail 142 of the tilting track mechanism 140, ensuring a smooth and controlled descent. Then, as shown in step S180, the tabletop 120 continues to slide into the internal space 114 of the main body housing 110 until it contacts the stop members 144, at which point the tabletop 120 is fully retracted and secured within the internal space 114 of the main body housing 110.

The primary application scenarios for the collapsible folding table assembly of the present invention include lecture halls or conference rooms, where the assembly can be integrated into walls or partitions to accommodate different teaching formats and meeting needs. Additionally, within transportation vehicles such as train compartments or airplanes, the assembly can be installed adjacent to seats to provide passengers with functional tabletops while maintaining walkway accessibility. Furthermore, medical facilities can utilize the assembly in patient rooms or treatment areas to address space-constrained situations.

Compared to existing technologies, the collapsible folding table assembly of the present invention offers multiple advantages. Its gravity-assisted storage tabletop and associated mechanisms simplify operation and reduce the need for manual force, enhancing user convenience. In summary, the collapsible folding table assembly of the present invention provides a comprehensive solution for environments requiring flexible and space-efficient workspaces. By innovatively integrating the tilting track mechanism and a series of technical features, the collapsible folding table assembly enhances user experience, optimizes space utilization, and offers durable performance suitable for a wide range of applications.

1. A collapsible folding table assembly, comprising:
a main body housing configured to be positioned adjacent to a seating area, the main body housing defining an internal space;
a tabletop configured to move between a storage position within the internal space of the main body housing and an extended position extending outwardly from the main body housing, wherein the tabletop is foldable for compact storage within the main body housing;
a rotational mechanism operatively connecting the tabletop to the main body housing;
an inclined track mechanism disposed within the main body housing, the inclined track mechanism comprising at least one guide rail inclined at a predetermined angle relative to a vertical axis of the main body housing; and
a guiding component operatively connected to the rotational mechanism and interactable with the guide rail, the guiding component configured to guide the tabletop smoothly along the guide rail of the inclined track mechanism;
wherein the inclined track mechanism facilitates gravity-assisted movement of the tabletop along the guide rail during the storage process.

2. The collapsible folding table assembly of claim 1, wherein the main body housing comprises:
an inner shell enclosing the internal space and accommodating mechanical components including the inclined track mechanism; and
an outer shell encasing the inner shell.

3. The collapsible folding table assembly of claim 2, wherein the space between the inner shell and the outer shell comprises noise reduction and vibration dampening materials selected from the group consisting of foam pads and rubber layers.

4. The collapsible folding table assembly of claim 1, wherein the tabletop includes a recessed area on its underside configured to facilitate gripping and handling by a user during the extension and storage processes.

5. The collapsible folding table assembly of claim 1, wherein the tabletop further comprises a hinge mechanism configured to allow the tabletop to fold upon itself.

6. The collapsible folding table assembly of claim 1, wherein the rotational mechanism comprises:
a pivot joint; and
a locking element disposed on the pivot joint.

7. The collapsible folding table assembly of claim 6, further comprising a support plate connected to the pivot joint, the support plate configured to provide a rigid support structure when the tabletop is in the extended position.

8. The collapsible folding table assembly of claim 1, wherein the guiding component comprises:
a guide block made of a low-friction material, the guide block operatively interacting with the guide rail to prevent lateral movement; and
a roller connected to the guide block, the roller configured to roll along the surface of the guide rail.

9. The collapsible folding table assembly of claim 1, further comprising a supporting structure operatively connected between the rotational mechanism and the guiding component.

10. The collapsible folding table assembly of claim 1, wherein the inclined track mechanism includes a stop member at a lower end thereof, the stop member configured to secure the tabletop in the storage position within the main body housing and prevent the tabletop from descending beyond a predetermined position.
